(19) United States
(12) Patent Application Publication
(10) Pub. No.: US 2019/0176499 A1
(43) Pub. Date: Jun. 13, 2019

(54) DIGITAL PRINTING MACHINE

(71) Applicant: ARIOLI S.P.A., Gerenzano (VA) (IT)

(72) Inventor: Carmelo Zocco, Saronno (IT)

(21) Appl. No.: 16/323,445

(22) PCT Filed: Aug. 4, 2017
(86) PCT No.: PCT/IB2017/054798

§ 371 Date: Feb. 5, 2019

(30) Foreign Application Priority Data
Aug. 9, 2016 (IT) 102016000083741

(51) Int. Cl. B41J 29/393; B41J 19/00; B41J 19/20

(52) U.S. Cl. CPC B41J 29/393; B41J 19/202; B41J 19/005

(57) ABSTRACT

A digital printing machine includes moving organs suitable for advancing a textile in a determined direction and a printing station. The printing station includes: a cross-beam extending lengthwise substantially orthogonal to the determined direction; a printing carriage having a frame and a printing device; a first moving apparatus adapted to move the printing carriage along the cross-beam; and a control unit associated with said printing device and substantially integral with the cross-beam, the control unit being configured to supply power to at least the first moving apparatus and control signals to the printing device. The control unit is connected to the printing carriage by way of an electrical connection to supply power to the first moving apparatus, and by way of an optical connection to supply the control signals to the printing device.

### TECHNICAL FIELD

The present invention relates to a digital printing machine, particularly a roll to roll machine.

### PRIOR ART

A digital printing machine of the roll to roll type operates on a textile, which initially is wound about a first roll, is unwound, associated with a guide belt, subjected to digital printing (e.g., ink-jet printing), dried and wound again onto a second roll.

Such machine comprises a base, a cross-beam and a printing carriage.

The base supports the cross-beam; the printing carriage moves along the cross-beam, in a direction substantially orthogonal to the advancement direction of the textile.

The carriage typically is connected electrically to the rest of the machine to receive both the power (movement along the cross-beam and vertical movement) and to receive the control signals intended for the printing device mounted on the carriage.

The Applicant has verified that problems in receiving such control signals occur with a certain frequency. In particular, the following may occur:
one or more data packets are not received by the printing device and therefore the printing of a specific portion of textile is not performed;
one or more data packets undergo distortions or are modified by electromagnetic noise, so that the print executed is different from the one desired.

The Applicant has also noted that a source of disturbance capable of creating the aforesaid problems consists of the “power” connection that brings power to the carriage. Indeed, for matters of simplicity and distribution of the components, the data cables (that bring the control signals to the printing device) and the power cables (that bring the power to the various components) are kept close to one another so as to substantially follow the same path.

This necessarily induces interferences and disturbances which as mentioned, have a negative impact on the reception of the data by the printing device.

The prior art proposes the use of isolating and shielding elements as a solution, which in addition to not resolving the problem in a satisfactory manner, results in increasing the complexity and costs of the structure of the machine.

### OBJECTS AND SUMMARY OF THE INVENTION

It is therefore the object of the present invention to propose a digital printing machine, particularly a roll to roll machine, capable of drastically reducing the probability of error in receiving data and control signals from the printing device mounted on the printing carriage.

It is another object of the invention to make available a digital printing machine, particularly a roll to roll machine, that is characterized by a simple and affordable structure.

It is a further object of the invention to provide a digital printing machine, particularly a roll to roll machine, in which the transmission of data/signals to the printing device mounted on the printing carriage may be carried out in a quick and secure manner.

These and other objects again are substantially achieved by a digital printing machine, particularly a roll to roll machine, as described in the appended claims.

### BRIEF DESCRIPTION OF THE DRAWINGS

Further features and advantages shall be more apparent from the detailed description of a preferred, but not exclusive, embodiment of the invention.

Such description is made herein below with reference to the accompanying drawings, also provided for indicative only and therefore not limiting purposes, in which:

FIGS. 1-2 show block diagrams representative of the invention;

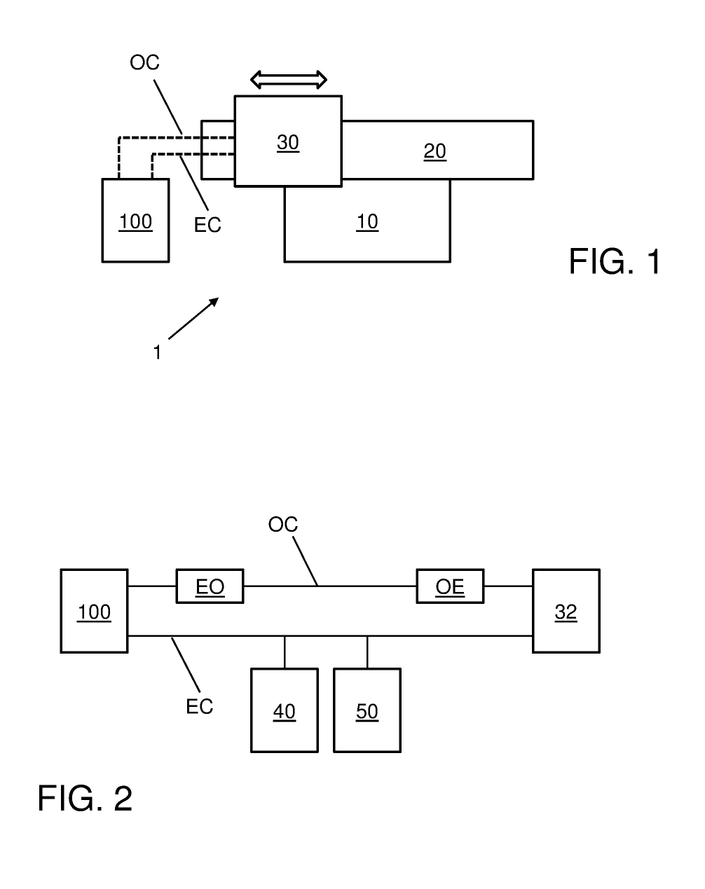

FIG. 3 shows a perspective diagrammatical view of a first part of the machine in FIG. 1-2;

FIG. 4 shows a perspective diagrammatical view of a second part of the machine in FIG. 1-2;

FIG. 5 shows a perspective diagrammatical view of a third part of the machine in FIGS. 1-2.

### DETAILED DESCRIPTION OF THE INVENTION

With reference to the accompanying drawings, 1 indicates a printing machine according to the invention.

The printing machine 1 preferably is a roll to roll machine, that is a machine in which the textile is initially wound onto a first roll, then it is unwound for printing, and finally it is rewound onto a second roll after drying.

The machine 1 firstly comprises a base (10).

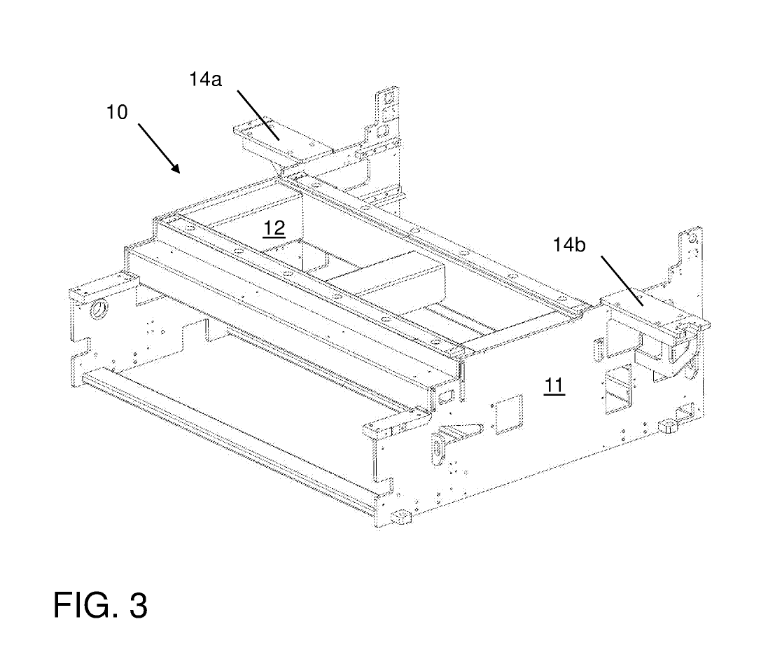

The base 10 (FIG. 3) comprises at least two vertical walls 11, 12, and one or more transverse portions joining said vertical walls and integral therewith.

The base mainly serves the purpose of supporting the cross-beam 20, which is better described below.

To this end, the base 10 has a resting zone 14a-14b on which the cross-beam 20 is rested and fixed.

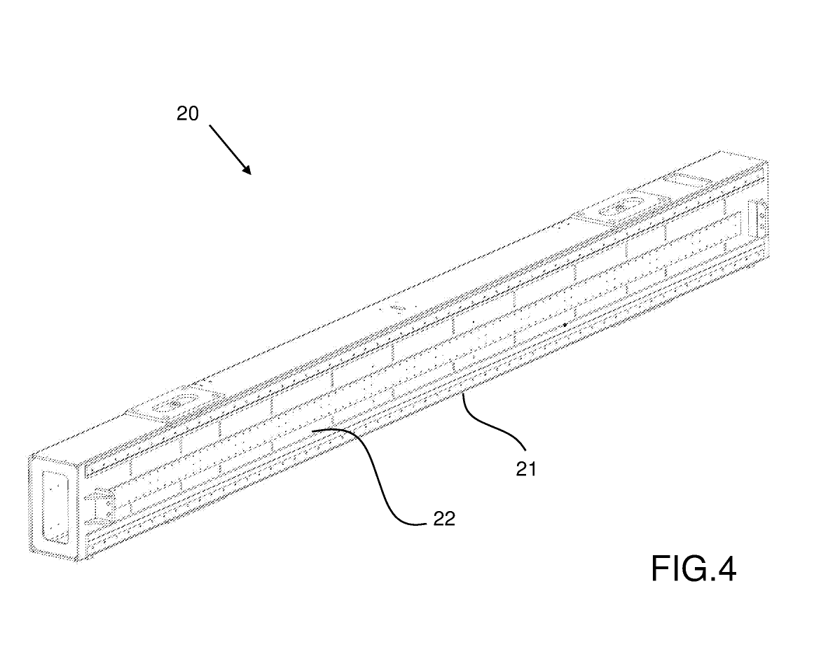

The cross-beam 20 (FIG. 4) has an elongated shape, for example a substantially parallelepiped shape.

Preferably, the cross-beam 20 has a base wall 21 suitable for being rested on the resting zone 14a-14b of the base 10.

Preferably, the cross-beam 20 also has a front wall 22 having a guide for a printing carriage 30.

The printing carriage 30 comprises a frame 31 and a printing device 32, supported by said frame 31.

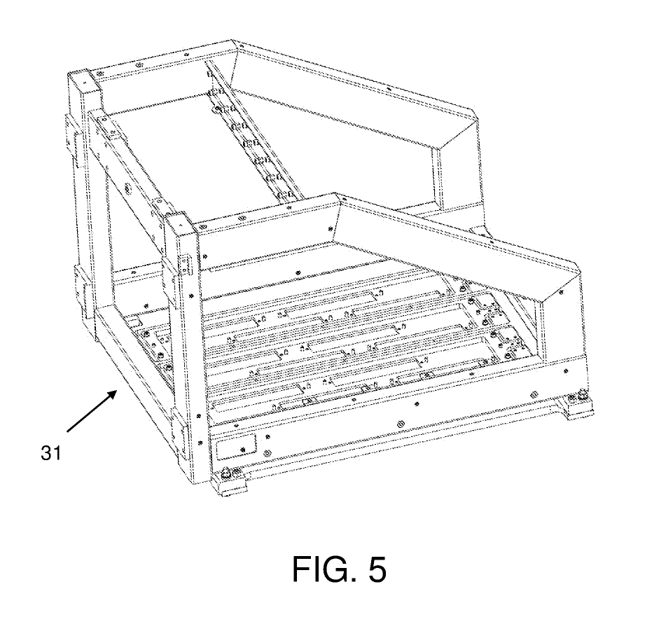

The frame 31 (FIG. 5) is mounted on the cross-beam 20 so as to be moved along it by substantially straight alternating motion. In other words, two respective stroke end positions are defined at the ends of the cross-beam 20, and by supporting the printing device 32, the frame 31 is continuously moved between the two stroke end positions.

The printing device 32 may be for example, an ink-jet printing device.

There are also provided first moving means 40 adapted to move the printing carriage 30 along the cross-beam 20 (FIGS. 4-5).

Such first moving means 40 may comprise for example, an electromechanical actuator or a pneumatic actuator; alternatively, any actuator capable of obtaining the above-described movement may be used.

The machine 1 further comprises second moving means 50 adapted to move the printing device 32 in a vertical direction, substantially orthogonal to the lengthwise extension of the cross-beam 20.

The second moving means 50 may comprise for example, an electromechanical actuator or a pneumatic actuator; alternatively, any actuator capable of obtaining the above-described movement may be used.

Preferably, the second moving means 50 are mounted on the frame 31 so as to conveniently act on the printing device 32.

The machine 1 further comprises a control unit 100 associated with the printing device 32.

The control unit 100 substantially is integral with the fixed parts of the machine 1, such as for example the base 10 and the cross-beam 20.

The control unit 100 serves the purpose of receiving the input printing data, for example in the form of digital image, and of sending corresponding control signals to the printing device 32 so that the latter may replicate the decorations provided on the textile. The configuration and setup data required for a suitable operation of the machine 1 are also entered in the control unit 100.

The control unit 100 is also configured to receive power from the power network and to distribute it to different parts of the machine 1 in a suitable manner. In particular, the power may be supplied to the printing device 32, the first moving means 40, the second moving means 50, etc.

According to the invention, the control unit 100 is connected with the printing carriage 30 by means of an electrical connection EC obtained with an electric cable that is in itself known.

Due to this connection, the electrical parts of the printing carriage 30 (printing device 32, first moving means 40, second moving means 50, etc.) may be powered.

The control unit 100 is also connected to the printing device 32 by means of an optical connection OC, made for example like an optical fibre.

The control unit 100 may send the printing device 32 data and/or control signals by means of such optical connection OC so that the printing activity provided is executed.

In greater detail, the control unit 100 is configured in a native manner to generate control signals in electronic format. The latter are converted into optical format by means of a first electro-optical converter EO.

The signals and/or data thus converted are transmitted to the printing device 32 by means of the optical connection OC.

The printing device 32 is configured in a native manner to receive control signals and data in electronic format; therefore it is provided for a second electro-optical converter OE, interposed between the optical connection OC and the printing device 32 itself, to convert the control signals into an electronic format and/or the received data into an optical format.

In light of the above, the advantages obtained by the invention are apparent.

Firstly, the probability of error in receiving data and control signals from the printing device mounted on the printing carriage is drastically reduced.

The overall structure of the machine is also made simpler and more affordable because there is no need to prepare specific isolations and shields between the power connection and the data connection.

The rapidity and security of the data transmission from the control unit to the printing device are also improved.

1. A digital printing machine, particularly roll to roll machine, comprising:
a) moving organs, suitable for advancing a textile in a determined direction;
b) a printing station, comprising:
i. a cross-beam, extending lengthwise substantially orthogonal to said determined direction;
ii. a printing carriage, comprising a frame and a printing device;
iii. first moving means, adapted for moving said printing carriage along said cross-beam;
iv. a control unit, associated with said printing device and substantially integral with said cross-beam, said control unit being configured to supply power to at least said first moving means and control signals to said printing device;
wherein said control unit is connected to said printing carriage by means of an electrical connection (EC) to supply power to said first moving means, and by means of an optical connection (OC) to supply said control signals to said printing device.

2. The machine according to claim 1 wherein said optical connection (OC) comprises an optical fibre.

3. The machine according to claim 1, wherein said control unit comprises a first electro-optical converter (EO) to convert control signals and/or electrical data in an optical format.

4. The machine according to claim 1, wherein said printing device is associated with a second electro-optical converter (OE) configured to convert control signals in an electric format and/or received data in an optical format.
